(19) United States
(12) Patent Application Publication
(10) Pub. No.: US 2005/0103840 A1
(43) Pub. Date: May 19, 2005

(54) Anti-fraud apparatus and method for protecting valuables

(76) Inventor: Julian D. Boles, London (GB)

Correspondence Address: LADAS & PARRY, 26 WEST 61ST STREET, NEW YORK, NY, 10023, US

(21) Appl. No.: 10/499,851

(22) PCT Filed: Dec. 20, 2002
(86) PCT No.: PCT/GB02/05881

(30) Foreign Application Priority Data
Dec. 20, 2001 (GB) 0130540.8

(51) Int. Cl. G06F 17/60

(52) U.S. Cl. 235/385; 340/5.8; 705/28

(57) ABSTRACT

An arrangement for certifying and checking gem stones (12) and other valuables comprises an electron microscope (11) controlled by a computer (1) and arranged to acquire digitised electron micrographs of characteristic regions of the gem stone or other valuable, particularly the culet (13) or girdle (14) which are typically highly irregular and therefore highly characteristic of individual stones. The digitised electron micrographs are encrypted and written to an RFID (7) which can be embedded in a plastics certificate (10) of in some cases a concealed on the valuable itself. Any tampering with the gem stone (12) or other valuable can be detected by reading the stored micrographs in the tag (7) and comparing them with micrographs newly acquired from the gem stone (12) or valuable as presented for verification. For extra security, the digitised encrypted micrographs are also stored in a remote database which can also include transaction data and can be linked to a credit card database of a financial institution.

The present invention relates to a method and apparatus for characterising valuables, particularly but not exclusively precious or semi-precious stones, to identification certificates obtainable by the apparatus or method, and to methods of checking for fraudulent transactions or operations on a valuable, particularly but not exclusively precious or semi-precious stones. The invention also relates to electronically tagged valuables.

It is conventional to characterise diamonds and other precious semi-precious stones by their carat (weight), colour, clarity and cut, known as the 4C's. These characteristics can be checked relatively easily by accurate weighing and optical examination and are conventionally recorded on a printed certificate which accompanies the gem and evidences its authenticity. However, the colour and clarity of a diamond are somewhat subjective and it is not unknown for fraudulent substitutions to be made in traded gems.

One approach to solving the above problems involves marking the gem and providing image data on a certificate—as disclosed in U.S. Pat. No. 5,899,503.

Furthermore, a stolen diamond can effectively acquire a new identity by being re-cut, enabling it to be traded on the legitimate market with a low risk of detection and only a small loss in weight.

More generally, valuables such as gems, objets d'art and items of scientific value such as meteorites are not always easy to identify and are frequently the subject of fraudulent operations such as forgery or alteration or fraudulent transactions e.g. after being stolen by substitution for a similar item of higher value.

GB 2,358,541A discloses optical apparatus for capturing a three-dimensional image of a diamond. However the resulting digitised images are subject to degradation by pixellation and are limited in resolution.

An object of the present invention is to overcome or alleviate at least some of the above problems.

In a first aspect the invention provides a method of characterising a cut or uncut precious or semi-precious stone comprising the steps of acquiring a high resolution image of at least one characteristic feature of the stone, digitising said image and storing the digitised image in association with an identifier of the stone. By a high resolution image is meant an image of resolution sufficiently high to define features such as irregularities which are characteristic of the individual stone. Preferably the resolution is higher than optical resolution.

Preferably the image is an electron micrograph and the selected characteristic feature is an irregular region at the boundary of two or more facets, e.g. at the culet or (in the case of an emerald cut diamond) the keel which are highly characteristic of an individual gem stone, especially at the resolution of an electron microscope.

Preferably the digitised image is stored in an electronic tag. A particularly preferred electronic tag is the ME1 Hitachi-Maxell RFID chip as made by Hitachi. Such tags are highly miniaturised and can be written to and read from in a contactless manner and incorporated permanently in a certificate in a tamper-proof manner. For example, the tag can be sealed within a certificate of plastics material.

Other preferred features of this aspect of the invention are defined in the dependent claims.

Cut or uncut precious or semi-precious stones that have been characterised by the method defined above are also included within the first aspect of the invention.

In a second aspect the invention provides an identification certificate for a cut or uncut precious or semi-precious stone, the certificate including an electronic tag in which a digitised image of at least one characteristic feature of the individual stone is stored.

Preferably the irregular region is as described above, particularly the culet, keel, girdle, table or crown and preferably the electronic tag is an RFID (Radio Frequency Identification) tag.

Preferably the digitised image is an electron micrograph and preferably the digitised image is stored in encrypted form. Preferably the electronic tag is permanently secured to the certificate in a tamper-proof manner.

In a third aspect the invention provides apparatus for certifying a valuable, the apparatus comprising means for acquiring a high (preferably higher-than-optical) resolution digitised image of at least one characterising region of the valuable, means for encrypting said digitised image and writing means arranged to write said encrypted digitised image to an electronic identifier tag associated with said valuable. Such apparatus can be used to provide genuine proof of both authenticity and ownership.

Preferably the apparatus further comprises transmitting means arranged to transmit said encrypted digitised image and an identifier for valuable to a remote server posting a database of such encrypted digitised images and identifiers.

Preferably the image acquiring means comprises an electron microscope.

In a fourth aspect the invention provides a method of checking for fraudulent transactions involving or operations on a valuable, the method comprising the steps of acquiring a high (preferably higher-than-optical) resolution image of at least one characterising region of the valuable, reading a similar image from an electronic identifier tag associated with the valuable and comparing the images.

Preferably the method comprises the further step of receiving from a database of such images a previously acquired digitised image having an identifier corresponding to an identifier store in said electronic identifier tag. Each identifier can be stored in association with its corresponding digitised image in the database and accordingly a digitised image can be retrieved by selecting the appropriate identifier.

In a preferred embodiment, financial transaction data pertaining to the valuable as identified by an identifier stored in said electronic identifier tag are received from a database. This database can either be the same database as the image database referred to above, or a completely separate database maintained by e.g. a financial institution such as a bank or a credit card or insurance company. This feature enables a register of transactions in a given valuable to be kept, so that any attempted transactions in a stolen valuable can be detected by comparison with this register.

If the valuable is a cut or uncut precious or semi-precious stone, the characterising region is preferably an irregular region of the stone, e.g. the culet, keel, girdle, table or crown facets as noted above.

Preferably the digitised images are stored in encrypted form and are decrypted prior to the comparison.

In a fifth aspect the invention provides a valuable having secured thereto a hidden electronic identifier tag, the electronic identifier tag having a stored image of at least one characterising region of the valuable and an identifier of the valuable.

Preferably the electronic tag is an RFID (Radio Frequency Identification) tag or the like, since such tags can be made in highly miniaturised form and hidden quite easily, particularly in larger valuables such as paintings or furniture.

Any copy of the valuable can easily be detected by scanning for the tag. Any tampering with the valuable can be detected by acquiring a fresh image of one or more characteristic regions and comparing these images with the corresponding stored images in the tag.

Preferably the stored image or images are of higher-than-optical resolution in order to discourage normal fraudulent alteration which is dependent upon the faker's eyesight with, at best, enhancement by optical means such as a magnifying glass. In this aspect the acquired image need not be an electron micrograph and accordingly this aspect of the invention is applicable to valuables unable to be imaged by a scanning electron microscope (SEM), for example because they are too large to fit inside the imaging chamber. In a less preferred embodiment the images could be optical.

In general, the advantages of the invention in its various aspects arise from the highly detailed information which can be stored securely, either in a very small electronic memory in an electronic tag associated with the valuable (e.g. incorporated in a certificate associated with the valuable or even hidden in the valuable itself or remotely e.g. in a database on a remote server. Preferably the image data is encrypted in order to provide further security.

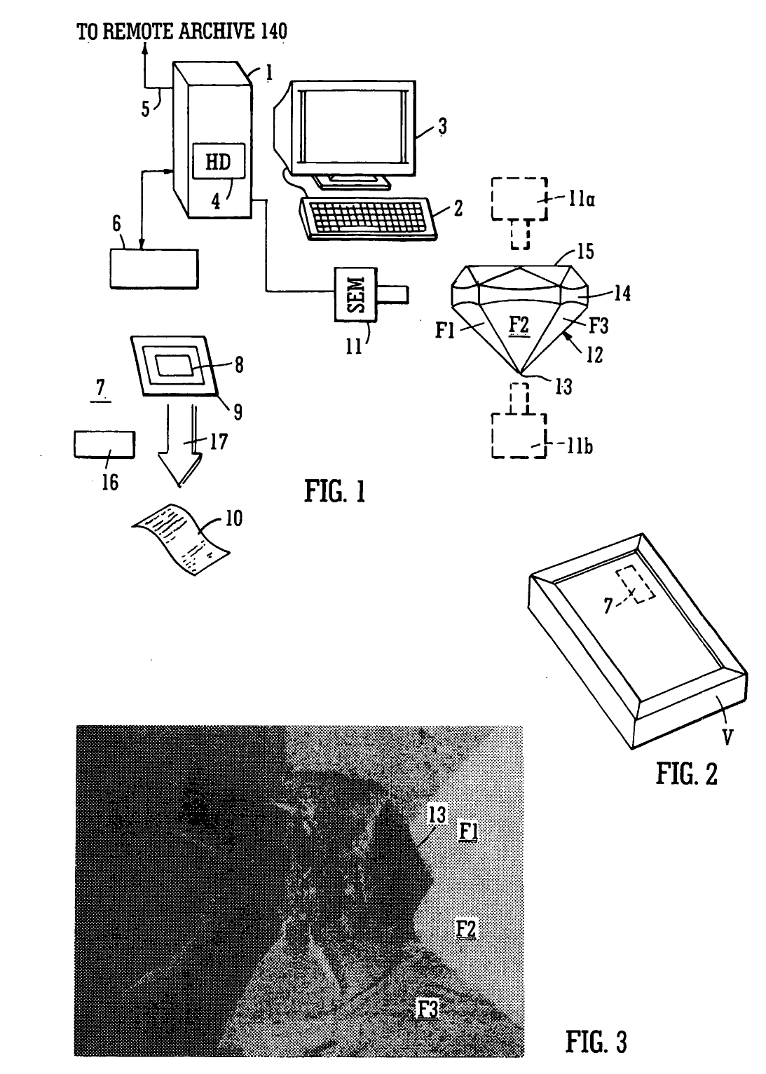

Preferred embodiments of the invention are described below, by way of example only, with reference to FIGS. 1 to 4 of the accompanying drawings, wherein:

FIG. 1 is a diagrammatic representation of apparatus for certifying or verifying a cut or uncut precious or semi-precious stone or other valuable;

FIG. 2 is a diagrammatic perspective view showing a valuable having an identifier tag hidden thereon in accordance with another aspect of the invention;

FIG. 3 is an example of an electron micrograph of the culet of a diamond as obtained by the apparatus of FIG. 1; and

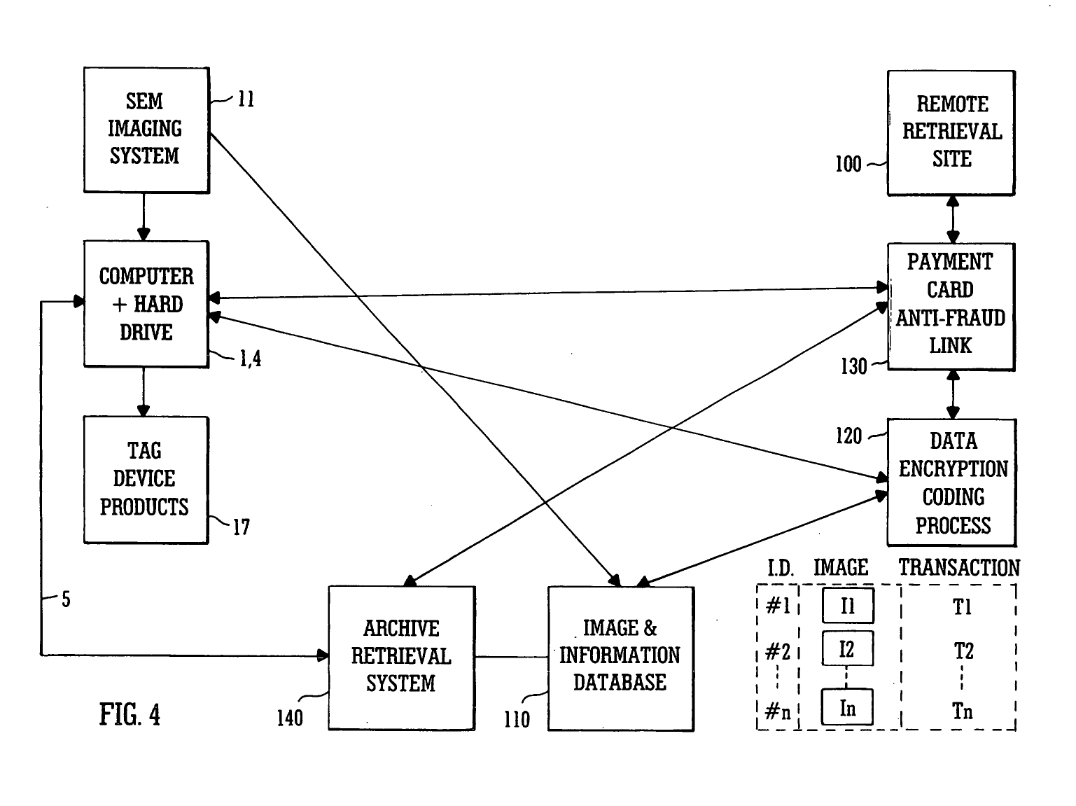

FIG. 4 is a block diagram illustrating a hardware and software system incorporating the apparatus of FIG. 1.

The apparatus shown in FIG. 1 comprises a computer 1 having a hard disk 4 (and a conventional microprocessor provided with RAM and ROM and a conventional operating system) controlled from a keyboard 2 and optionally a pointing device such as a mouse (not shown). The computer 1 has a suitable interface (not shown) for the output of a scanning electron microscope 11 and images from the scanning electron microscope preferably with optical colour images can be displayed on a screen 3, stored on hard disk 4 and encrypted under the control of any suitable encryption software running on computer 1.

The resulting digitised images are output to an inductive writer 6 which is arranged to store the images in a memory 8 of a miniature RFID (Radio Frequency Identification) tag 7, such as Hitachi-Maxwell ME1 chip which picks up the wireless signals by means of a miniature on-chip 9. The tag typically has dimensions of 2.5 mm×2.5 mm×0.6 mm.

The tag 7 now contains encrypted digitised electron micrograph images and preferably also optical images in non-volatile memory and can be read by reader/writer 6.

The tag is then processed in an encapsulation device 16 which, in a process indicated by arrow 17, embeds the tag in a certificate 10 which is suitably a plastic card on which can be printed a further data indicating e.g. the carat, colour, clarity and cut of the stone and one or more visual images of the stone. The images are provided with a unique identifier which is entered under keyboard control and transmitted from reader/write 6 to memory 8.

In FIG. 1, a stone 12 is indicated on a greatly enlarged scale and it will be noted that the scanning electron microscope 11 is directed at a girdle region 14 or table region 15 which may or may not be cut or polished but which is highly characteristic of an individual gem stone in view of the large number of facet boundaries and minute irregularities it contains. The scanning electron microscope is also arranged to view the crown 15 of the stone 12 as indicated at 11a and to view the culet 13 as indicated at 11b. Encrypted digitised electron micrographs are acquired, preferably in at least these three views.

Referring to FIG. 3, the culet 13 and the adjacent tips of facets F1, F2 and F3 are shown as they appear in the electron micrograph acquired by the scanning electron microscope in position 11b and the irregularities in this characteristic region are readily apparent. The magnification is ×1000.

The apparatus of FIG. 1 can also be used for verifying a diamond 12 or another gem stone or indeed any other valuable having an associated electronic tag containing digitised electron micrographs or other physical data of characteristic regions which can be used for identification purposes. These previously obtained electron micrographs are retrieved by computer I either directly from the associated RFID tag 7 using the reader/writer 6 or by accessing a remote archive 140 (FIG. 4—discussed in more detail below) using a communications link 5. These are displayed on the screen 3 and compared (e.g. visually) with electron micrographs acquired from corresponding view points from the gem stone 12 or other valuable as presented for evaluation. If the images match, then the gem stone or other valuable can be considered to be authentic. Provided that a suitable selection of images are compared, it is highly likely that any re-cutting or tampering with the stone will be detectable.

It should be noted that at an uncut extremity, a “natural” is often left at the culet 13 or at other regions of a gem stone to ensure that the weight just exceeds one of the standard weights, e.g. 1.00 carat. The value per carat of a gem stone falling fractionally below one of the standard carat weights is far less than the value per carat of a gem stone lying just above a standard carat. The “naturals” of a gem stone are normally highly irregular and therefore highly characteristic of an individual stone and are particularly suitable for imaging by an electron microscope for identification purposes. However, it is envisaged that other higher than optical resolution modes of imaging may be employed, e.g. X-ray or laser imaging or tomography, magnetic resonance imaging (MRI) or scanning tunnelling microscopy (STM).

In a variant of the method of certification illustrate in FIG. 1, which is particularly applicable to larger valuables (V2) such as paintings, sculptures and furniture (but with increasing miniaturisation of RFID tags may also be applicable to smaller valuables including jewellery, even gem stones), the RFID tag 7 may be attached to the valuable V in a concealed fashion (e.g. in a rear corner of a painting as shown in FIG. 2). One or more images of characteristic regions of the valuable V are stored in digitised encrypted form in the RFID tag 7 in a manner similar to that described with reference to FIG. 1 and the valuable V can subsequently be authenticated by electronically scanning for the digitised image information stored in the RFID tag 7, retrieving and decrypting this information using the computer controlled reader/writer 6 of FIG. 1 and comparing the digitised images with freshly acquired images of the same characteristic regions.

In a development of the arrangement shown in FIG. 1, transaction data or other financial data pertaining to the valuable V or gem stone 12 can be stored in association with the digitised images in a remote database and retrieved by computer 1 using a communications link 5 in order to establish a complete chain of ownership back to the original producer of the gem stone 12 or, more generally, the first recorded owner of a valuable V.

Such a system is shown schematically in FIG. 4. Referring to FIG. 4, a scanning electron microscope imaging system 11 is linked to a hard drive 4 of a computer and is arranged to generate RFID tags storing encrypted digitised electron micrographs by process 17 as already described in relation to FIG. 1. A communications link 5 links the computer with its hard drive to an archive retrieval system 140 (e.g. a server) which hosts an image and information database 110. As shown, this database includes fields for the identifier (# symbol 1 to # symbol n), images (I1, I2. . . . In) and transactions (T1, T2 . . . Tn) such that inputting the identifier of a gem stone or other valuable enables the corresponding sets of images and transactions to be retrieved by computer 1.

The archive retrieval system 140 is also linked to a payment card anti-fraud link 130 which connects to a remote retrieval site 100 owned e.g. by a financial institution such as a credit card or insurance company or bank. Only if the gem stone 12 or valuable V is authenticated does the financial institution authorise a credit card or other payment from a buyer wishing to acquire the gem stone or other valuable from the purported owner. The payment card anti-fraud link 130 may also provide credit card verification or other credit information to computer 1 which may be located at a retail outlet.

Finally, data encryption and decryption may be provided by a separate block 120 which communicates with database 110, payment card anti-fraud link 130 and the computer 1.

1-34. (canceled)

35. A method of characterising a cut or uncut precious or semi-precious stone comprising the steps of acquiring a high resolution image of at least one characteristic feature of the stone, digitising said image and storing the digitised image in association with an identifier of the stone in an RFID (Radio Frequency Identification) tag.

36. A method according to claim 35, wherein said digitised image is an electron micrograph.

37. A method according to claim 35, wherein said RFID tag is tamper-proof.

38. A method according to claim 35, wherein said RFID tag is permanently secured to an identification certificate in a tamper-proof manner.

39. A method according to claim 38, wherein said tag is sealed within a certificate of plastics material.

40. A method according to claim 35, wherein said digitised image is stored in said RFID tag in encrypted form.

41. A method according to claim 35, wherein said digitised image is stored remotely in an electronic database so as to be retrievable therefrom using said identifier.

42. A method according to claim 41, wherein said digitised image is stored in said electronic database in association with financial transaction data pertaining to the stone.

43. A method according to claim 35, wherein said characteristic feature is an irregularity at the boundary of two or more facets of a cut stone.

44. A method according to claim 43, wherein said selected irregular region is at the culet, keel, girdle, table or crown.

45. An identification certificate for a cut or uncut precious or semi-precious stone, the certificate including an RFID tag in which a digitised image of at least one characteristic feature of the individual stone is stored.

46. An identification certificate according to claim 45, wherein said digitised image is stored in encrypted form.

47. An identification certificate according to claim 45, wherein said digitised image is an electron micrograph.

48. An identification certificate according to claim 45, wherein said RFID tag is permanently secured to said certificate in a tamper-proof manner.

49. An identification certificate according to claim 48, wherein said certificate is composed of plastics material within which said electronic tag is sealed.

50. Apparatus for certifying a valuable, the apparatus comprising means for acquiring a high resolution digitised image of at least one characterising region of the valuable, means for encrypting said digitised image and writing means arranged to write said encrypted digitised image to an RFID (Radio Frequency Identification) tag associated with said valuable.

51. Apparatus according to claim 49, further comprising transmitting means arranged to transmit said encrypted digitised image and an identifier of the valuable to a remote server posting a database of such encrypted digitised images and identifiers.

52. Apparatus according to claim 51, wherein said image acquiring means comprises an electron microscope.

53. A method of checking for fraudulent transactions involving or operations on a valuable, the method comprising the steps of acquiring a high resolution image of at least one characterising region of the valuable, reading a similar image from an RFID (Radio Frequency Identification) tag associated with the valuable, and comparing the images.

54. A method according to claim 53, comprising the further step of receiving from a database of such images a previously acquired digitised image having an identifier corresponding to an identifier stored in said RFID tag.

55. A method according to claim 53, comprising receiving from a database financial transaction data pertaining to the valuable as identified by an identifier stored in said RFID tag.

56. A method according to claim 53, wherein said valuable is a cut or uncut precious or semi-precious stone and said characterising region is an irregular region of the stone.

57. A method according to claim 53, wherein the digitised images are stored in encrypted form and are decrypted prior to the comparison.

58. A valuable having secured thereto a hidden RFID (Radio Frequency Identification) tag, the electronic identifier tag having a stored image of at least one characterising region of the valuable and an identifier of the valuable.
